(19) United States
(12) Patent Application Publication
(10) Pub. No.: US 2024/0351445 A1
(43) Pub. Date: Oct. 24, 2024

(54) VEHICLE COMPRISING A RECHARGEABLE BATTERY AND MEANS FOR DETERMINING A MAXIMUM ACCEPTABLE POWER FOR THE BATTERY DURING A CHARGING PHASE

(71) Applicants: AMPERE S.A.S., Boulogne Billancourt (FR); RENAULT S.A.S., Boulogne Billancourt (FR)

(72) Inventor: Laurent OLLIVIER, Guyancourt (FR)

(73) Assignees: AMPERE S.A.S., Boulogne Billancourt (FR); RENAULT S.A.S., Boulogne Billancourt (FR)

(21) Appl. No.: 18/291,064

(22) PCT Filed: Jul. 19, 2022
(86) PCT No.: PCT/EP2022/070214

§ 371 Date: Jan. 22, 2024

(30) Foreign Application Priority Data
Jul. 23, 2021 (FR) FR2108039

(51) Int. Cl. B60L 7/10; B60L 58/12

(52) U.S. Cl. CPC B60L 7/10; B60L 58/12; B60L 2240/545

(57) ABSTRACT

A system for supplying power to a rechargeable electrical accumulation battery for a motor vehicle driven by an electric or hybrid powertrain includes a device for determining a maximum acceptable power for the battery depending on a first maximum power corresponding to a regenerating phase and on a second maximum power corresponding to a phase of charging the battery.

### TECHNICAL FIELD

The subject of the invention is electric battery management systems, and in particular on-board electric battery management systems intended to drive an electric or hybrid motor vehicle.

### PRIOR ART

Motor vehicle batteries can be either recharged at electrical stations when the vehicle is stationary, or be recharged by recovering, through the electric motor, some of the kinetic energy from the vehicle when it decelerates. Recovering energy in such a way is commonly called regenerative braking.

Batteries can deteriorate or age, and thus reduce their capacity to store energy. This aging depends on the conditions in which the batteries are used when a vehicle is traveling.

In order to preserve the integrity of the battery, it is proposed to limit its charging power.

This limitation is all the more important when the state of charge of the battery is high.

The charging capacity gradually drops toward zero as the battery approaches full charge.

Likewise, when the temperature of the battery is typically below 0° C.

In addition, when the charging power exceeds a predetermined threshold as a function at least of the chemical nature and of the dimensions of the cells of the battery, the latter loses its integrity.

Furthermore, when the battery is made of lithium-ion, lithium layers have been observed to be deposited on its electrodes when charging powers are too high. The charging capacity of the battery is greatly reduced in order to limit this phenomenon.

Consequently, the manufacturers of such batteries provide a map indicating the maximum acceptable power for the battery as a function of its temperature and of its state of charge during a phase of charging by means of a power supply station.

The battery can, furthermore, be recharged during a travel phase, during a braking phase or when lifting the foot, known as a regeneration phase.

The maximum acceptable power is higher here but can, however, be applied only for a shorter duration of the order of ten seconds in order not to damage the battery.

Manufacturers have, therefore, developed a second map of the maximum acceptable power for the battery as a function of its temperature and of its state of charge during a regeneration phase.

However, if the regeneration phase proves to be longer than the duration defined by said second map, the battery is liable to be damaged.

A so-called modulation strategy, described in the patent bearing the reference FR2994027, is, therefore, implemented by a battery management system (BMS) in order to gradually limit the quantity of power provided to the battery.

Such a strategy consists in limiting the maximum acceptable power, at each instant of the regeneration phase, which depends both on a value read from the first map of maximum acceptable power values during the charging phase and on a value read from the second map of maximum acceptable power values during the regeneration phase.

In other words, it is a case of gradually switching from limiting the maximum acceptable power value originating from the second map to limiting the maximum acceptable power value read from the first map.

Now, this strategy is used only during the regeneration phase and in no case during the charging phase.

The battery is, therefore, deprived of high charging power, which, when it is allowed for a predefined period of time, does not damage the battery. The charging potential of the battery during the charging phase is therefore only partially utilized.

The aim of the invention is therefore to improve the electric power supply systems for the motor vehicle battery during charging phases.

### SUMMARY OF THE INVENTION

In view of the above, the subject of the invention is a power supply system for a rechargeable electric storage battery for an electric or hybrid motor vehicle, the battery being able to be recharged during regeneration phases and during charging phases, the system comprising means for determining a maximum acceptable power for the battery.

The means for determining the maximum acceptable power for the battery comprise a first map making it possible to read a first maximum power from the temperature and from the state of charge of the battery, a second map making it possible to read a second maximum power from the temperature and from the state of charge of the battery, the first map comprising first maximum power values corresponding to a regeneration phase and the second map comprising second maximum power values corresponding to a battery charging phase, and calculation means for calculating said maximum acceptable power for the battery during the charging phase as a function of the first maximum power and of the second maximum power.

In other words, the calculation means are configured to utilize the first map and the second map in order to implement the modulation strategy during the battery charging phase.

The modulation strategy makes it possible, therefore, to gradually increase the charging power until a first maximum acceptable charging power value originating from the first map and corresponding to the state of charge and to the temperature of the battery at the instant t is reached.

Thus, at an equivalent temperature and state of charge, the first maximum acceptable charging power value is greater than a corresponding second maximum charging power value originating from the second map.

The change in maximum acceptable charging power will then substantially follow the values originating from the first map for a predetermined duration before gradually decreasing to reach a second maximum power value originating from the second map.

Finally, as soon as the maximum acceptable power has reached the second value, the maximum acceptable power will substantially follow the maximum power values indicated in the second map as charging occurs.

Advantageously, the calculation means are configured to calculate the sum of the first power assigned a first coefficient α(t) between 0 and 1 and the second power assigned a second coefficient equal to 1−α(t).

The first coefficient α(t) is chosen so as to obtain a limitation chosen from among the first maximum power (if it is equal to one), the second maximum power (if it is equal to 0) and a weighting of these two powers if it is between 0 and 1.

Preferably, the calculation means are configured to adjust the value of the first power so as to be less than or equal to a predetermined threshold value when the first coefficient α(t) is equal to 1.

Battery durability is affected when there is a significant difference between the first charging power and the second charging power at an equivalent temperature and state of charge.

It is, therefore, proposed to keep the maximum acceptable charging power value less than or equal to said predetermined threshold value.

Preferably, the calculation means are configured to keep the first coefficient α(t) at 1 for a predetermined duration.

In other words, it is a case of calculating said maximum acceptable power for the battery only as a function of the first maximum power for said predetermined duration.

Advantageously, the battery is composed of one or of several cells, the system comprising means for measuring the voltage across the terminals of a cell and means for limiting the maximum acceptable power for the battery providing a third maximum power value calculated as a function of a maximum voltage value and of the measured cell voltage.

Calculating a third maximum power value as a function of these two parameters makes it possible to protect the battery.

Another subject of the invention is an electric or hybrid motor vehicle comprising a rechargeable electric storage battery, a braking system making it possible to recover energy, the battery being able to be recharged during regeneration phases and during charging phases, and a power supply system for said battery as defined above.

Another subject of the invention is a method for controlling the charge of a rechargeable electric storage battery of an electric or hybrid motor vehicle comprising a braking system making it possible to recover energy, the battery being able to be recharged during regeneration phases and during charging phases.

The method comprises a step of determining a first maximum power corresponding to a regeneration phase, a step of determining a second maximum power corresponding to a battery charging phase, and a step of calculating the maximum acceptable power for the battery during the charging phase as a function of the first maximum power and of the second maximum power.

Advantageously, calculating said maximum acceptable power comprises summing the first power assigned a first coefficient α(t) between 0 and 1 and the second power assigned a second coefficient equal to 1−α(t).

Preferably, the first power value is adjusted so as to be less than or equal to a predetermined threshold value when the first coefficient α(t) is equal to 1.

Preferably, the first coefficient α(t) is kept at 1 for a predetermined duration.

Advantageously, when the battery is composed of one or of several cells, the voltage across the terminals of a cell is measured and the maximum acceptable power for the battery is limited on the basis of a third maximum power value calculated as a function of a maximum voltage value and of the measured cell voltage.

### BRIEF DESCRIPTION OF THE DRAWINGS

Other aims, features and advantages of the invention will become apparent on reading the following description, which is given merely by way of non-limiting example, and with reference to the appended drawings, in which:

FIG. 1 illustrates a first map and a second map comprising maximum power values during a regeneration phase and during a phase of charging a battery of a motor vehicle according to the prior art, respectively,

FIG. 2 schematically depicts a power supply system 2 for the battery according to one embodiment of the invention, and

FIG. 3A and

FIG. 3B depict a first graph and a second graph of the change in maximum acceptable power for the battery during the charging phase according to two implementations of the invention.

### DETAILED DISCLOSURE OF THE EMBODIMENTS OF THE INVENTION

For a motor vehicle battery comprising one or several individual cells, maximum acceptable power maps can be developed by means of maps of the internal resistance of one battery cell, for example.

These maps can be obtained by preliminary calibration steps and make it possible to read this resistance as a function of the state of charge of the battery and of its temperature.

The state of charge of the battery depends directly on the open circuit voltages (OCVs) of cells and can therefore be measured by means of voltage sensors.

The maximum allowed voltage V_{LimitPIN} for a cell through which a current flows during a regeneration phase with energy recovery, and the maximum allowed voltage V_{LimitPCHG} for a cell through which a current flows during a charging phase, can also be obtained by calibration.

Together these data make it possible to determine the maximum acceptable powers for the battery during the charging phase and during the regeneration phase by means of equation 1:

$${P}_{BAT}^{MAXPIIN} = \frac{{V}_{LimitPIN} - OCV}{D C {R}_{cell}} * {V}_{LimitPIN} \qquad EQ . 1$$

$${P}_{BAT}^{M AXPCHG} = \frac{{V}_{L i m itPCHG} - OCV}{D C {R}_{cell}} * {V}_{LimitPCHG}$$

where:
P_{BAT}^{MAXPIN}: First maximum power allowed during the regeneration phase, and
P_{BAT}^{MAXPCHG}. Second maximum power allowed during the charging phase.

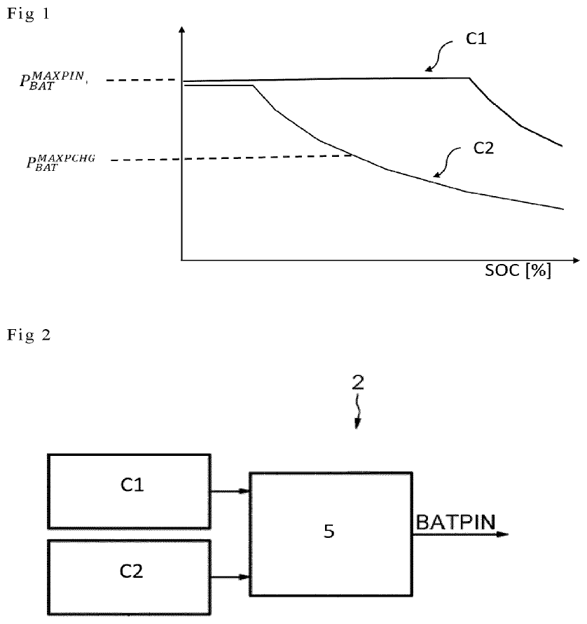

As illustrated in FIG. 1, a first map C1 comprising first maximum power P_{BAT}^{MAXPIN} as a function of the state of charge of the battery SOC expressed as a values percentage can then be formed.

FIG. 1 furthermore illustrates a second map C2 comprising second maximum power values P_{BAT}^{MAXPCHG} as a function of the state of charge of the battery SOC.

At each instant (labeled t) a maximum acceptable power for the battery is thus obtained with equation 2:

$$BATPIN ( t ) = α ( t ) * {BATPIN}_{POWERMAP} ( t ) + ( 1 - α ( t ) ) * {BATPCHG}_{POWRRMAP} ( t ) \qquad EQ . 2$$

where:
BATPIN(t): Maximum acceptable power for the battery at the instant t;
BATPIN_{POWERMAP}(t): First maximum acceptable power in the regeneration phase at the instant t obtained on the first map C1;
BATPCHG_{POWERMAP}(t): Second maximum acceptable power in the charging phase at the instant t obtained on the second map C2;
α(t): First coefficient between zero and one.

Thus, if the first coefficient α(t) is equal to 1, the maximum acceptable power BATPIN(t) for the battery is the first maximum acceptable power in the regeneration phase BATPIN_{POWERMAP}(t), which is a high value.

In contrast, if the first coefficient α(t) is equal to zero, the maximum acceptable power BATPIN(t) for the battery is the second maximum acceptable power in the charging phase BATPCHG_{POWERMAP}(t), which is a low value and which can be applied for a long time without damaging the battery.

FIG. 2 depicts a power supply system 2 comprising means for determining the maximum acceptable power BATPIN(t) during the battery charging phase.

Such means for determining the maximum acceptable power BATPIN(t) are configured to calculate equation 2.

By using, on the one hand, the first map C1 comprising the first maximum acceptable power values BATPIN_{POWERMAP}(t) corresponding to the regeneration phases and, on the other hand, the second map C2 comprising the second maximum acceptable power values BATPCHG_{POWERMAP}(t) corresponding to the charging phases, calculation or modulation means 5 intended to provide the value of the maximum acceptable charging power BATPIN(t) for the battery can be used.

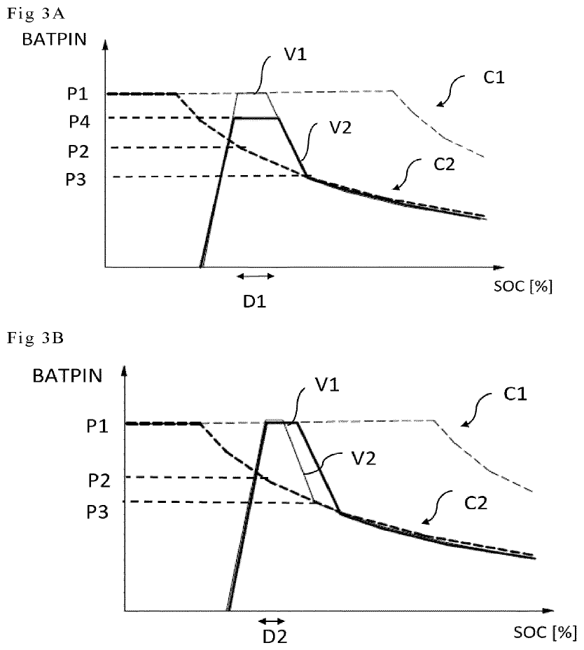

Thus, as illustrated in FIG. 3A, the first solid-line curve V1 depicts the change in maximum acceptable charging power BATPIN(t), expressed in watts, as a function of the state of charge SOC of the battery or of the voltage for a given temperature.

The modulation strategy makes it possible, here, to gradually increase the maximum acceptable charging power BATPIN(t) until a first charging power value P1 originating from the first map C1 and corresponding to the state of charge SOC at the instant t is reached.

Thus, at an equivalent temperature and state of charge, the first maximum acceptable charging power value P1 is greater than a corresponding second maximum acceptable charging power value P2 originating from the second map C2.

The change in maximum acceptable charging power BATPIN(t) will then substantially follow the values BATPIN_{POWERMAP}(t) originating from the first map C1 for a first predetermined duration D1 before gradually decreasing to reach a third maximum power value P3 originating from the second map C2.

By way of example, the first predetermined duration D1 is between 10 seconds and a few minutes.

Finally, as soon as the maximum acceptable power BATPIN(t) has reached the third value P3, the latter will substantially follow the second maximum power values BATPCHG_{POWERMAP}(t) indicated in the second map C2 as battery charging occurs.

Furthermore, it should be noted that the durability of the battery can be impaired when there is a significant difference between the first charging power BATPIN_{POWERMAP}(t) and the second charging power BATPCHG_{POWERMAP}(t) at an equivalent temperature and state of charge SOC.

For example, the difference can be of the order of several tens of kilowatts (KW).

The calculation means 5 can, therefore, be configured to adjust the value of the first maximum power BATPIN_{POWERMAP}(t) so as to be less than or equal to a predetermined threshold value P4 when the coefficient α(t) is equal to 1.

In this case, it is a second solid-line curve V2 which depicts the change in maximum acceptable charging power BATPIN(t) as a function of the state of charge SOC of the battery.

It should be noted that the modulation strategy can be applied to all the temperature values.

As a variant, and as illustrated in FIG. 3B, the calculation means 5 are configured to keep the coefficient α(t) at 1 for a second predetermined duration D2, between a few seconds and a few minutes, in order to protect the battery against high variability of the charging power BATPIN(t) during the charging phase.

Furthermore, the invention is not limited to these embodiments and implementations but encompasses all their variants.

The invention relates, for example, to applications equipped with batteries the ratio between current and charging capacity (C-rate) of which is greater than 1.

1-11. (canceled)

12. A power supply system for a rechargeable electric storage battery for an electric or hybrid motor vehicle, the battery being configured to be recharged during regeneration phases and during charging phases, the system comprising:
means for determining a maximum acceptable power for the battery, wherein the means for determining the maximum acceptable power for the battery comprise a first map configured to allow a first maximum power to be read from the temperature and from the state of charge of the battery, a second map configured to allow a second maximum power to be read from the temperature and from the state of charge of the battery, the first map comprising first maximum power values corresponding to a regeneration phase and the second map comprising second maximum power values corresponding to a battery charging phase, and
calculation means for calculating said maximum acceptable power for the battery during the charging phase as a function of the first maximum power and of the second maximum power.

13. The power supply system as claimed in claim 12, wherein the calculation means are configured to calculate the sum of the first power assigned a first coefficient α(t) between 0 and 1 and the second power assigned a second coefficient equal to 1−α(t).

14. The power supply system as claimed in claim 13, wherein the calculation means are configured to adjust the value of the first power so as to be less than or equal to a predetermined threshold value when the first coefficient α(t) is equal to 1.

15. The power supply system as claimed in claim 13, wherein the calculation means are configured to keep the first coefficient α(t) at 1 for a predetermined duration.

16. The power supply system as claimed in claim 12, wherein the battery is comprised of one or of several cells, the system comprising means for measuring the voltage across the terminals of a cell and means for limiting the maximum acceptable power for the battery providing a third maximum power value calculated as a function of a maximum voltage value and of the measured cell voltage.

17. An electric or hybrid motor vehicle comprising:
a rechargeable electric storage battery;
a braking system configured to recover energy, the battery being configured to be recharged during regeneration phases and during charging phases; and
the power supply system as claimed in claim 12 to supply power to said battery.

18. A method for controlling a charge of a rechargeable electric storage battery of an electric or hybrid motor vehicle comprising a braking system configured to recover energy, the battery being configured to be recharged during regeneration phases and during charging phases, the method comprising:
determining a first maximum power corresponding to a regeneration phase;
determining a second maximum power corresponding to a battery charging phase; and
calculating a maximum acceptable power for the battery during the charging phase as a function of the first maximum power and of the second maximum power.

19. The method as claimed in claim 18, wherein calculating said maximum acceptable power comprises summing the first power assigned a first coefficient α(t) between 0 and 1 and the second power assigned a second coefficient equal to 1−α(t).

20. The method as claimed in claim 19, further comprising adjusting the first power value so as to be less than or equal to a predetermined threshold value when the first coefficient α(t) is equal to 1.

21. The method as claimed in claim 19, further comprising keeping the first coefficient α(t) at 1 for a predetermined duration.

22. The method as claimed in claim 18, wherein, when the battery is composed of one or of several cells, the voltage across the terminals of a cell is measured and the maximum acceptable power for the battery is limited based on a third maximum power value calculated as a function of a maximum voltage value and of the measured cell voltage.
